(19) United States
(12) Patent Application Publication
(10) Pub. No.: US 2024/0073103 A1
(43) Pub. Date: Feb. 29, 2024

(54) DYNAMIC CONFIGURATION AND DISCOVERY OF SECURITY EDGE PROTECTION PROXY

(71) Applicant: T-Mobile USA, Inc., Bellevue, WA (US)

(72) Inventors: Joel Arends, Renton, WA (US); Nassereddine Sabeur, Bellevue, WA (US); Raymond T. Ball, Seattle, WA (US)

(21) Appl. No.: 17/897,054

(22) Filed: Aug. 26, 2022

(51) Int. Cl. H04L 41/122; H04L 67/141; H04L 67/56

(52) U.S. Cl. CPC H04L 41/122; H04L 67/141; H04L 67/56

(57) ABSTRACT

Systems, methods, and devices that relate to adapting the SEPP as a Network Function (NF) under the 5G SBA are disclosed. In one example aspect, a system for wireless communication includes a first SEPP network function located at an edge of a first network, a first network repository function in communication with the SEPP network function, and a root SEPP discovery node in communication with the first network repository function and a second network repository function of a second network. The second network repository function of the second network is in communication with a second SEPP network function located at an edge of the second network. The root SEPP discovery node is configured to store information of different SEPP network functions that include the first and the second SEPP network functions available in different networks globally or regionally.

### BACKGROUND

Mobile communication technologies are moving the world toward an increasingly connected and networked society. The Fifth-Generation (5G) wireless communication technology has evolved based on the Long-Term Evolution (LTE) communication technology and adopted a Service-Based Architecture (SBA) to provide a modular framework for applications. As compared to the fixed-function, application-based LTE architecture, the SBA allows 5G technology to fully realize its potential and to move to software and cloud-based open platforms.

### BRIEF DESCRIPTION OF THE DRAWINGS

FIG. 1A illustrates a 5G roaming system architecture.

FIG. 1B illustrates an example N32-c interface between the Security Edge Protection Proxies (SEPPs).

FIG. 1C shows an example N32-f interface that provides Application Level Security (ALS) between SEPPs.

FIG. 2 illustrates an example architecture that provides dynamic SEPP configuration and discovery in accordance with one or more embodiments of the present technology.

FIG. 3A is an example sequence flow for SEPP registration in accordance with one or more embodiments of the present technology.

FIG. 3B is an example sequence flow for SEPP subscription in accordance with one or more embodiments of the present technology.

FIG. 3C is an example sequence flow for SEPP discovery in accordance with one or more embodiments of the present technology.

FIG. 4 is a flowchart representation of a process for wireless communication in accordance with one or more embodiments of the present technology.

FIG. 5 is a flowchart representation of another process for wireless communication in accordance with one or more embodiments of the present technology.

FIG. 6 is a diagram that illustrates a wireless telecommunication network in which aspects of the disclosed technology are incorporated.

FIG. 7 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

Section headings are used in the present document only to improve readability and do not limit scope of the disclosed embodiments and techniques in each section to only that section. Certain features are described using the example of Fifth Generation (5G) wireless protocol. However, applicability of the disclosed techniques is not limited to only 5G wireless systems.

Conventionally, Security Edge Protection Proxies (SEPPs), which act as firewalls for incoming and outgoing traffic among networks, are configured manually and/or statically by the partner operators. With the exponential growth of wireless networks and increasing number of operators, such manual or static configuration and selection of SEPPs has become burdensome to the operators. To enable dynamic configuration and selection of SEPPs among partner operators, techniques that relate to adapting the SEPP as a Network Function (NF) under the 5G SBA are disclosed. In particular, a root SEPP discovery node can be used to manage available SEPP regionally and/or globally.

A secure network guarantees limited impact of a failure or an attack. In order to provide secure networks, Public Land Mobile Network (PLMN) operators expose the network functions to the Internetwork Packet Exchange (IPX) Network that are reachable only by partners. It is also a good security practice to have a firewall that filters traffic on transport and application layer. For control plane signaling traffic, this firewall is the Security Edge Protection Proxy (SEPP).

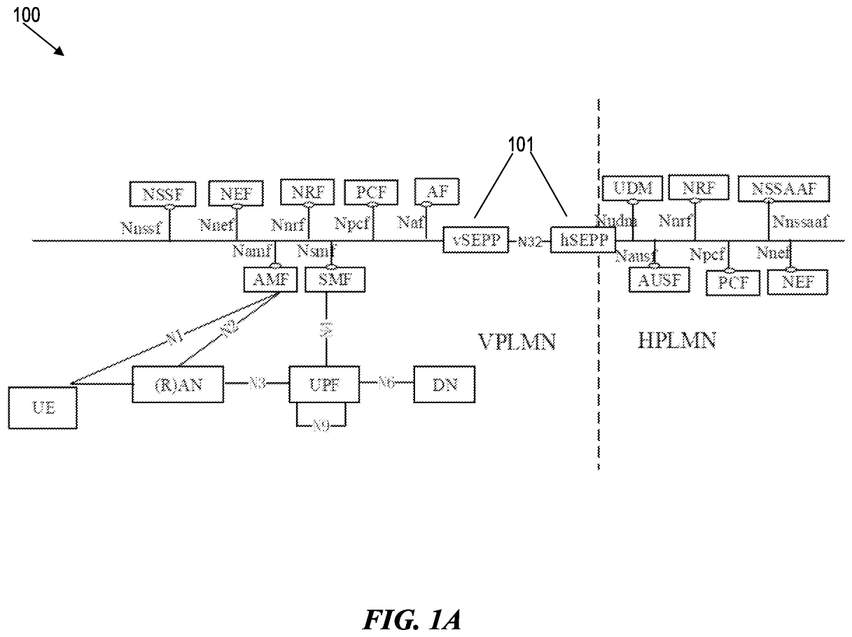

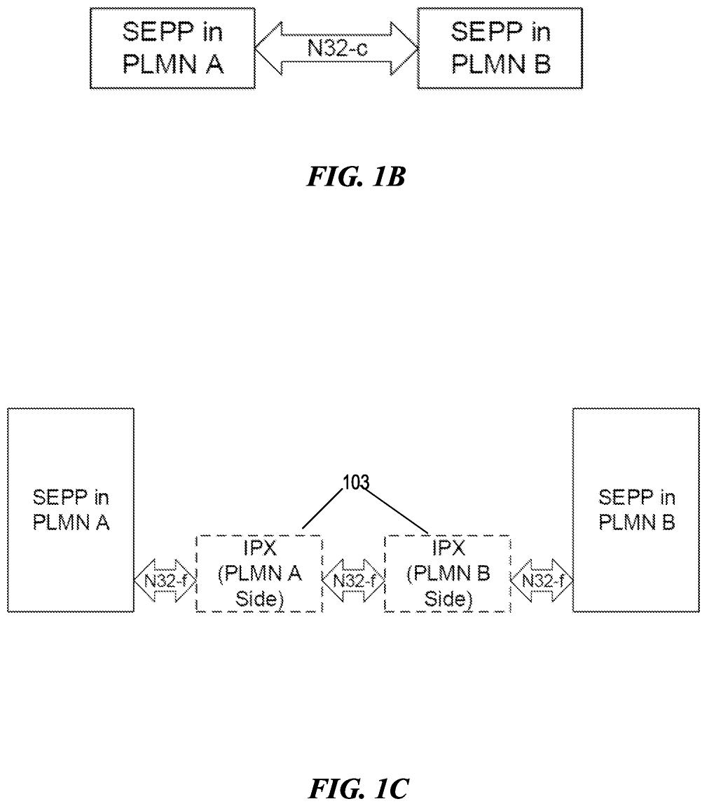

According to the Third-Generation Partnership Project (3GPP) standard, the SEPP is a non-transparent proxy that supports message filtering and policing on inter-PLMN control plane interfaces and topology hiding. The SEPP acts as a service relay between the service producer and the service Consumer. FIG. 1A illustrates a 5G service-based roaming system architecture 100. In this architecture 100, the SEPPs 101 sit at the perimeter of each network and enforce the protection policies, thereby ensuring integrity and confidentiality protection for the network elements.

As shown in FIG. 1A, under the 5G SBA, the SEPPs 101 communication via N32 interface. There are two types of N32 interfaces: N32-c interface and N32-f interface. FIG. 1B illustrates an example N32-c interface between the SEPPs for performing the initial handshake and negotiating the parameters to be applied for the actual N32 message forwarding. FIG. 1C shows an example N32-f interface that provides Application Level Security (ALS) between SEPPs. ALS provides message protection of information exchanged between Network Functions (NFs) as well as forwarding of the application layer protected message from a SEPP in one PLMN to another PLMN by via IPX providers 103 on the path.

Currently, operators have to manually provision SEPPs based on bilateral agreements, configuring each node directly and statically because the 3GPP standard does not specify a standardized way for one operator to discover another operator's SEPP address. However, with a large portfolio of hundreds of roaming partners, the static configuration and management of partner SEPPs can become burdensome and a highly resource and time intensive exercise for the operators. This patent document discloses techniques that can be implemented in various embodiments to enable dynamic configuration and selection of SEPP(s) using the service-based architecture of the 5G system. In particular, SEPP can function as a NF that is managed by the Network Repository Function (NRF) to perform dynamic registration, subscription, and discovery so as to enable connection establishment between SEPPs of different operators.

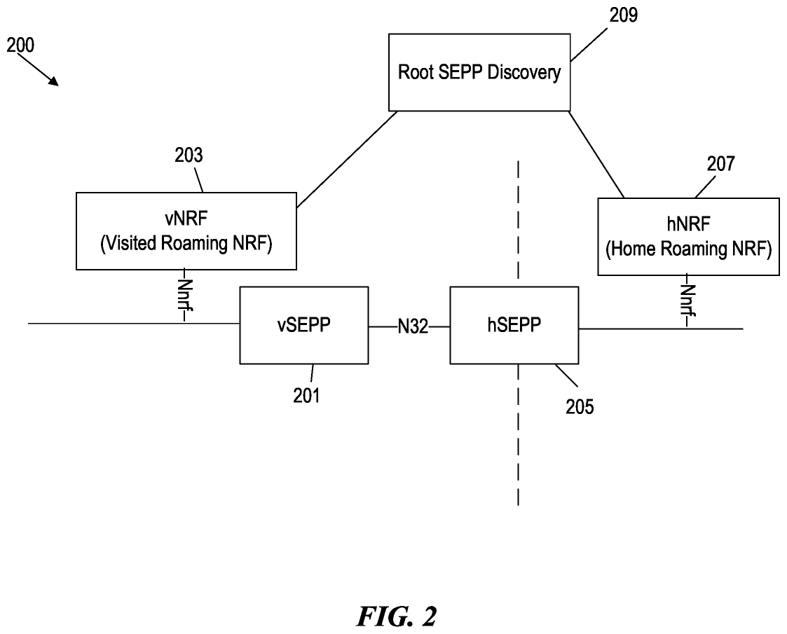

The NRF is a key NF of the 5G SBA that provides NF service registration, subscription, and discovery, enabling NFs to identify appropriate services in one another. FIG. 2 illustrates an example architecture 200 that provides dynamic SEPP configuration and discovery in accordance with one or more embodiments of the present technology. Consistent with the 5G SBA as shown in FIG. 1A, the visited SEPP (vSEPP) 201 in the visited network is in communication with its NRF (the visited roaming NRF) 203. The home SEPP (hSEPP) 205 in the home network is also in communication with its NRF (the home roaming NRF) 207. Both the visited roaming NRF and the home roaming NRF are in communication with a Root SEPP Discovery node 209.

In some embodiments, the Root SEPP Discovery node is implemented as an NRF that is consistent with the 3GPP standard to manage SEPP information of global or regional partners. The Root SEPP Discovery node/NRF can communication with the roaming NRF in each network via the Nnrf interface. In some embodiments, the Root SEPP Discovery node can be implemented as a global or regional gateway database. The Root SEPP Discovery node stores SEPP information of global or regional partners to enable dynamic discovery of SEPP.

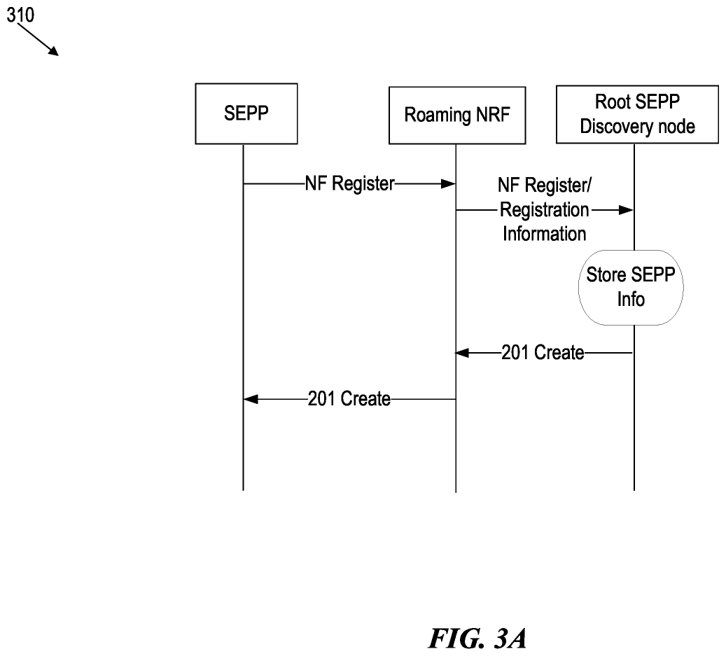

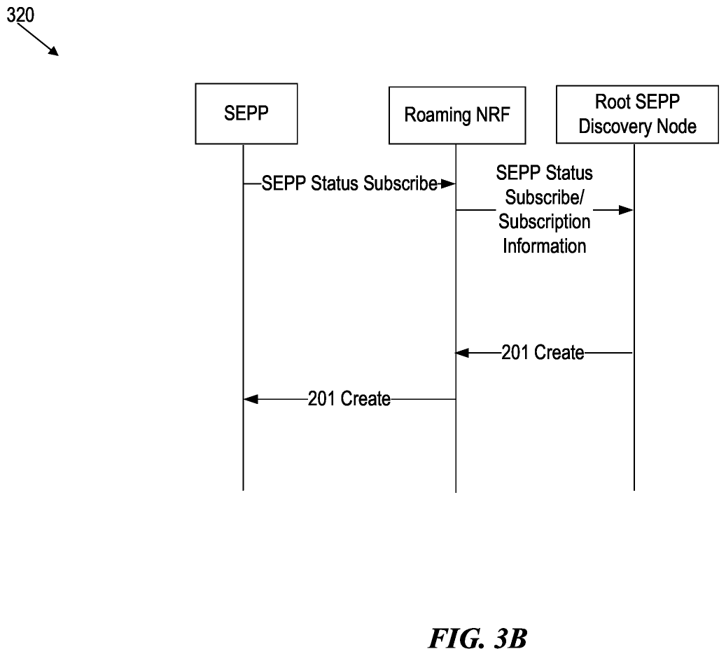

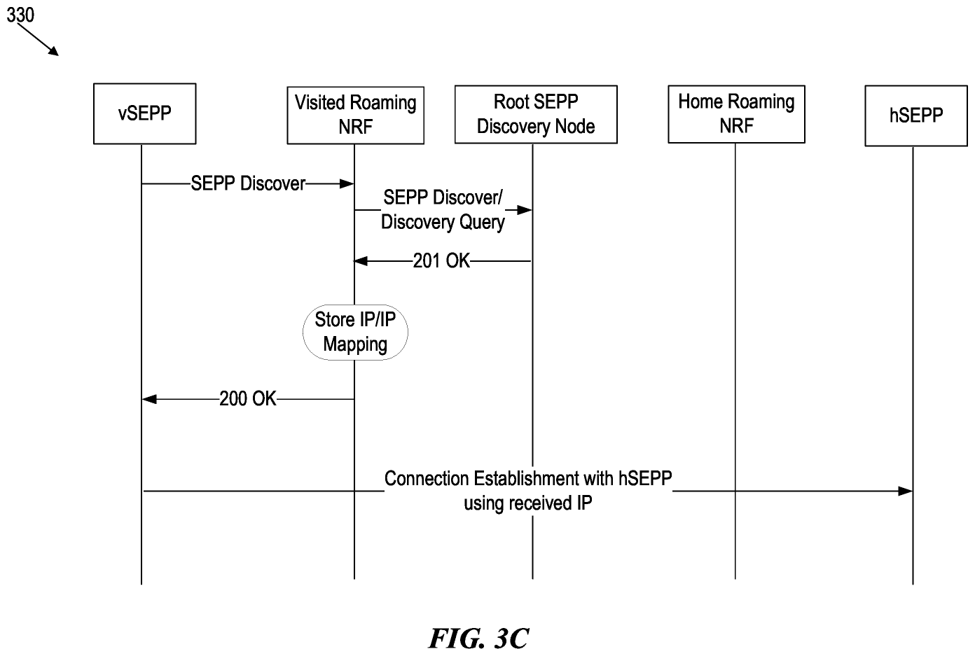

FIG. 3A is an example sequence flow 310 for SEPP registration in accordance with one or more embodiments of the present technology. When a new SEPP becomes available in the network, it sends an NF Register message to the corresponding roaming NRF to register itself. The NF Register message includes parameters of the SEPP together with the list of services exposed by the SEPP. The NF Register message can be in the format specified in 3GPP Technical Specification 29.510 for NFRegister. For example, a PUT request can be sent from the new SEPP to the roaming NRF. The PUT request can include Uniform Resource Identifier (URI) query parameters and/or a NF Profile. The NF Profile can include a variety of attributes, such as the unique identity of the NF instance, the type of the NF, etc.

The roaming NRF forwards the registration information to the Root SEPP Discovery node so that the Root SEPP Discovery node can store the information about the SEPP (e.g., the IP address, the URI, and/or the NF Profile). The Root SEPP Discovery node can confirm the registration by transmitting a confirmation message (e.g., a 201 Create message). When an operator takes down or replaces the SEPP, the SEPP can transmit a message (e.g., SEPP Deregister) to the roaming NRF to deregister itself. The roaming NRF can forward to the Root SEPP Discovery node to deregister or delete the relevant information about the SEPP.

FIG. 3B is an example sequence flow 320 for SEPP subscription in accordance with one or more embodiments of the present technology. In some embodiments, the SEPP can subscribe to the roaming NRF, which is in communication with the Root SEPP Discovery node, to obtain any updates or changes of other partner SEPPs. The roaming NRF can forward the subscription information or the SEPP Status Subscribe message to the Root SEPP Discovery node. The Root SEPP Discovery node confirms the subscription by transmitting a confirmation message (e.g., a 201 Create message). Upon successful subscription, the SEPP can receive updates or changes of status of other SEPPs from the Root SEPP Discovery node via the roaming NRF (e.g., by SEPP Status Notify) and adjust its own configuration if needed. For example, an NFUpdate message can be used to update the NF Profile. As another example, an NFStatusNotify message can be transmitted to alert the SEPP about the unavailability of certain requests. The SEPP also has the option to unsubscribe from the roaming NRF and/or the Root SEPP Discovery NRF by transmitting a SEPP Status Unsubscribe message.

FIG. 3C is an example sequence flow 330 for SEPP discovery in accordance with one or more embodiments of the present technology. In this example, the visited SEPP (vSEPP) has registered with the corresponding Visited Roaming NRF and the Root SEPP Discovery node. The vSEPP generates a discovery request with appropriate query parameters, such as the globally unique Subscription Permanent Identifier (SUPI). In some embodiments, the discovery request can be implemented as the Nnrf_NFDiscovery request. Additional parameters carried in the Nnrf_NFDiscovery, such as Data network access identifiers of the NFs being discovered, can be found in the 3GPP Technical Specification 29.510. The vSEPP transmits the discovery request (e.g., SEPP Discover message) to the Root SEPP Discovery node via the Visited Roaming NRF. If a home SEPP (hSEPP) is discovered successfully, the Root SEPP Discovery node sends a “200 OK” to the Visited Roaming NRF with the results indicating the hSEPP (e.g., the IP address of the hSEPP). The Visited Roaming NRF can store information about the vSEPP and/or hSEPP, such as the IP address(es) of the vSEPP and/or hSEPP. In some embodiments, the visited Roaming NRF stores a mapping of the originating vSEPP (e.g., the IP address of vSEPP) and the returned results (e.g., the IP address of hSEPP). In some embodiments, the “200 OK” message includes a validity period during which the results can be cached by the Visited Roaming NRF or the vSEPP. The Visited Roaming NRF then forwards the results to the vSEPP to allow the vSEPP to establish a connection with the hSEPP using the received IP address.

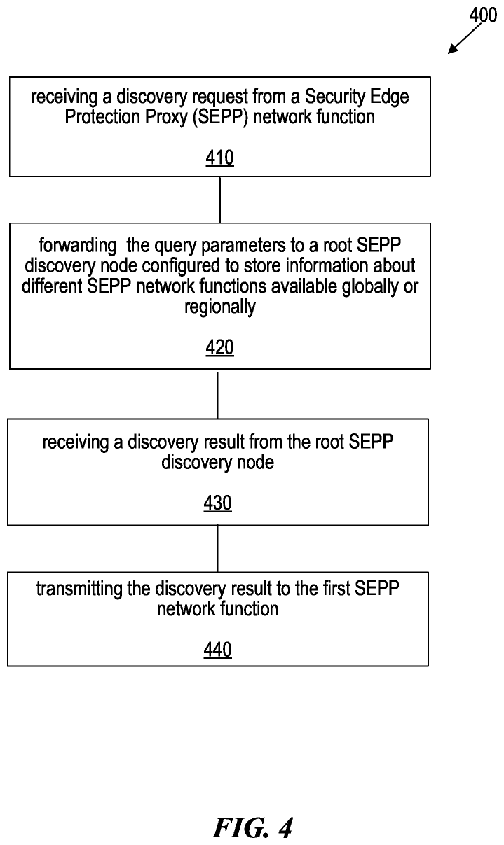

FIG. 4 is a flowchart representation of a method or a process 400 for wireless communication in accordance with one or more embodiments of the present technology. The process 400 includes, at operation 410, receiving, by a first network repository function in a first network, a discovery request from a first Security Edge Protection Proxy (SEPP) network function located at an edge of the first network, the discovery request comprising one or more query parameters. The process 400 includes, at operation 420, forwarding, by the first network repository function, the query parameters to a root SEPP discovery node configured to store information about different SEPP network functions available globally or regionally. The process 400 includes, at operation 430, receiving, by the first network repository function, a discovery result from the root SEPP discovery node, the discovery result comprising information about a second SEPP network function in a second network. The process 400 also includes, at operation 440, transmitting, by the first network repository function, the information about the second SEPP network function to the first SEPP network function.

In some embodiments, the process includes storing, by the first network repository function, the IP address of the second SEPP network function. In some embodiments, the discovery request comprises an IP address of the first SEPP network function and the process includes storing a mapping of the IP address of the first SEPP network function and the IP address of the second SEPP network function.

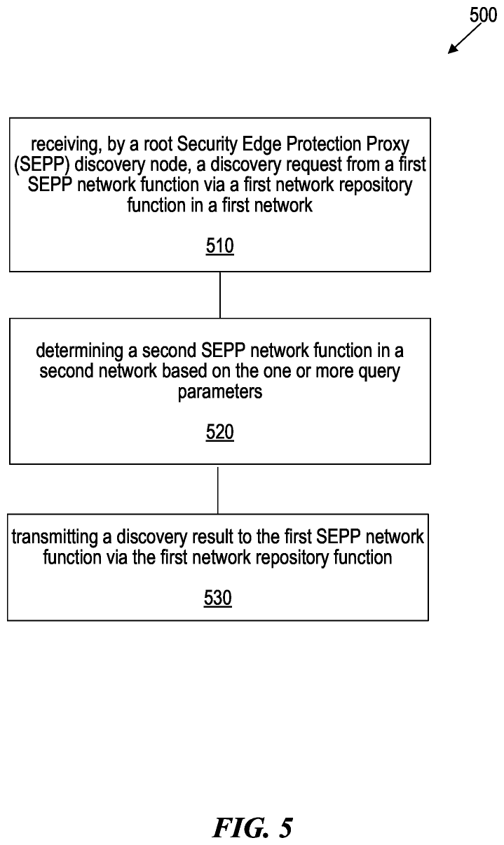

FIG. 5 is a flowchart representation of a method or a process 500 for wireless communication in accordance with one or more embodiments of the present technology. The process 500 includes, at operation 510, receiving, by a root Security Edge Protection Proxy (SEPP) discovery node, a discovery request from a first SEPP network function via a first network repository function in a first network. The root SEPP discovery node is configured to store information about different SEPP network functions available globally or regionally and the discovery request comprises one or more query parameters. The process 500 includes, at operation 520, determining, by the root SEPP discovery node, a second SEPP network function in a second network based on the one or more query parameters. The process 500 includes, at operation 530, transmitting, by the root SEPP discovery node, a discovery result to the first SEPP network function via the first network repository function. The discovery result comprises information about the second SEPP network function.

In some embodiments, the process includes storing, by the root SEPP discovery node, information of the first SEPP network function upon receiving a first registration request from the first SEPP network function via the first network repository function and storing, by the root SEPP discovery node, information of the second SEPP network function upon receiving a second registration request from the second SEPP network function via the second network repository function.

In some embodiments, the process includes receiving, by the root SEPP discovery node, a message from the first SEPP network function via the first network repository function subscribing to a status update of at least one other SEPP network function stored in the root SEPP discovery node and transmitting, by the root SEPP discovery node, a confirmation message to the first SEPP network function via the first network repository function in response to the message. In some embodiments, the process further includes transmitting, by the root SEPP discovery node upon detection of a trigger event, a status update message to the first SEPP network function via the first network repository function.

Wireless Communications System

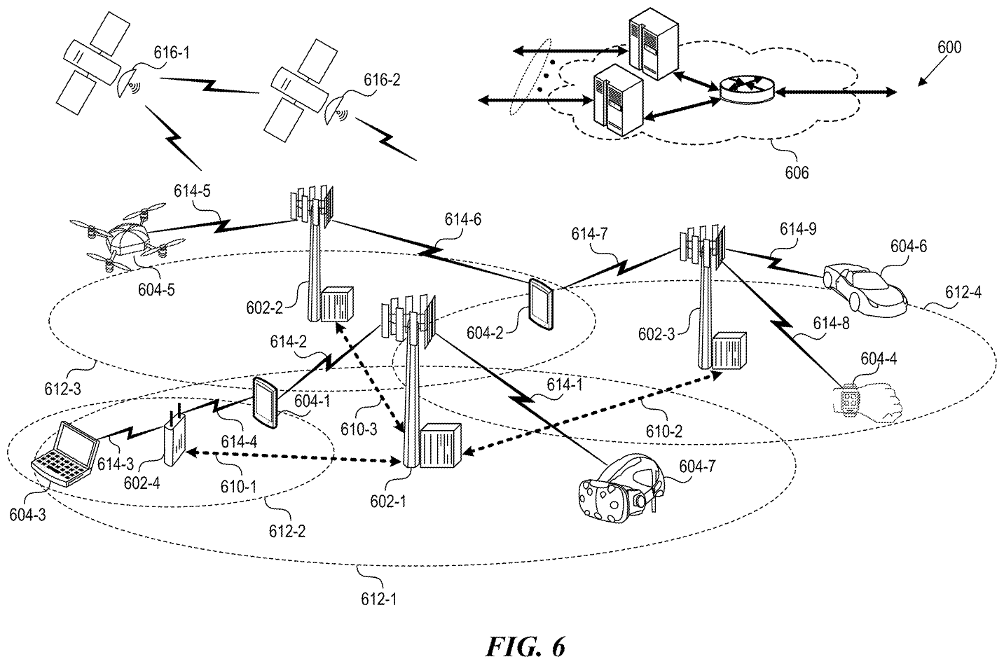

FIG. 6 is a diagram that illustrates a wireless telecommunication network 600 (“network 600”) in which aspects of the disclosed technology are incorporated. The network 600 includes base stations 602-1 through 602-4 (also referred to individually as “base station 602” or collectively as “base stations 602”). A base station is a type of network access node (NAN) that can also be referred to as a cell site, a base transceiver station, or a radio base station. The network 600 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 600 formed by the network 600 also include wireless devices 604-1 through 604-7 (referred to individually as “wireless device 604” or collectively as “wireless devices 604”) and a core network 606. The wireless devices 604-1 through 604-7 can correspond to or include network 600 entities capable of communication using various connectivity standards. For example, a 5G communication channel can use millimeter wave (mmW) access frequencies of 28 GHz or more. In some implementations, the wireless device 604 can operatively couple to a base station 602 over a long-term evolution/long-term evolution-advanced (LTE/LTE-A) communication channel, which is referred to as a 4G communication channel.

The core network 606 provides, manages, and controls security services, user authentication, access authorization, tracking, Internet Protocol (IP) connectivity, and other access, routing, or mobility functions. The base stations 602 interface with the core network 606 through a first set of backhaul links (e.g., S1 interfaces) and can perform radio configuration and scheduling for communication with the wireless devices 604 or can operate under the control of a base station controller (not shown). In some examples, the base stations 602 can communicate with each other, either directly or indirectly (e.g., through the core network 606), over a second set of backhaul links 610-1 through 610-3 (e.g., X1 interfaces), which can be wired or wireless communication links.

The base stations 602 can wirelessly communicate with the wireless devices 604 via one or more base station antennas. The cell sites can provide communication coverage for geographic coverage areas 612-1 through 612-4 (also referred to individually as “coverage area 612” or collectively as “coverage areas 612”). The geographic coverage area 612 for a base station 602 can be divided into sectors making up only a portion of the coverage area (not shown). The network 600 can include base stations of different types (e.g., macro and/or small cell base stations). In some implementations, there can be overlapping geographic coverage areas 612 for different service environments (e.g., Internet-of-Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 600 can include a 5G network 600 and/or an LTE/LTE-A or other network. In an LTE/LTE-A network, the term eNB is used to describe the base stations 602, and in 5G new radio (NR) networks, the term gNBs is used to describe the base stations 602 that can include mmW communications. The network 600 can thus form a heterogeneous network 600 in which different types of base stations provide coverage for various geographic regions. For example, each base station 602 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 600 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 600 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 600 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 604 and the base stations 602 or core network 606 supporting radio bearers for the user plane data. At the Physical (PHY) layer, the transport channels are mapped to physical channels.

Wireless devices can be integrated with or embedded in other devices. As illustrated, the wireless devices 604 are distributed throughout the system 600, where each wireless device 604 can be stationary or mobile. For example, wireless devices can include handheld mobile devices 604-1 and 604-2 (e.g., smartphones, portable hotspots, tablets, etc.); laptops 604-3; wearables 604-4; drones 604-5; vehicles with wireless connectivity 604-6; head-mounted displays with wireless augmented reality/virtual reality (ARNR) connectivity 604-7; portable gaming consoles; wireless routers, gateways, modems, and other fixed-wireless access devices; wirelessly connected sensors that provides data to a remote server over a network; IoT devices such as wirelessly connected smart home appliances, etc.

A wireless device (e.g., wireless devices 604-1, 604-2, 604-3, 604-4, 604-5, 604-6, and 604-7) can be referred to as a user equipment (UE), a customer premise equipment (CPE), a mobile station, a subscriber station, a mobile unit, a subscriber unit, a wireless unit, a remote unit, a handheld mobile device, a remote device, a mobile subscriber station, terminal equipment, an access terminal, a mobile terminal, a wireless terminal, a remote terminal, a handset, a mobile client, a client, or the like.

A wireless device can communicate with various types of base stations and network 600 equipment at the edge of a network 600 including macro eNBs/gNBs, small cell eNBs/gNBs, relay base stations, and the like. A wireless device can also communicate with other wireless devices either within or outside the same coverage area of a base station via device-to-device (D2D) communications.

The communication links 614-1 through 614-9 (also referred to individually as “communication link 614” or collectively as “communication links 614”) shown in network 600 include uplink (UL) transmissions from a wireless device 604 to a base station 602, and/or downlink (DL) transmissions from a base station 602 to a wireless device 604. The downlink transmissions can also be called forward link transmissions while the uplink transmissions can also be called reverse link transmissions. Each communication link 614 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 614 can transmit bidirectional communications using frequency division duplex (FDD) (e.g., using paired spectrum resources) or Time division duplex (TDD) operation (e.g., using unpaired spectrum resources). In some implementations, the communication links 614 include LTE and/or mmW communication links.

In some implementations of the network 600, the base stations 602 and/or the wireless devices 604 include multiple antennas for employing antenna diversity schemes to improve communication quality and reliability between base stations 602 and wireless devices 604. Additionally or alternatively, the base stations 602 and/or the wireless devices 604 can employ multiple-input, multiple-output (M IMO) techniques that can take advantage of multi-path environments to transmit multiple spatial layers carrying the same or different coded data.

In some examples, the network 600 implements 6G technologies including increased densification or diversification of network nodes. The network 600 can enable terrestrial and non-terrestrial transmissions. In this context, a Non-Terrestrial Network (NTN) is enabled by one or more satellites such as satellites 616-1 and 616-2 to deliver services anywhere and anytime and provide coverage in areas that are unreachable by any conventional Terrestrial Network (TN). A 6G implementation of the network 600 can support terahertz (THz) communications. This can support wireless applications that demand ultrahigh quality of service requirements and multi-terabits per second data transmission in the 6G and beyond era, such as terabit-per-second backhaul systems, ultrahigh-definition content streaming among mobile devices, AR/VR, and wireless high-bandwidth secure communications. In another example of 6G, the network 600 can implement a converged Radio Access Network (RAN) and Core architecture to achieve Control and User Plane Separation (CUPS) and achieve extremely low User Plane latency. In yet another example of 6G, the network 600 can implement a converged Wi-Fi and Core architecture to increase and improve indoor coverage.

Computer System

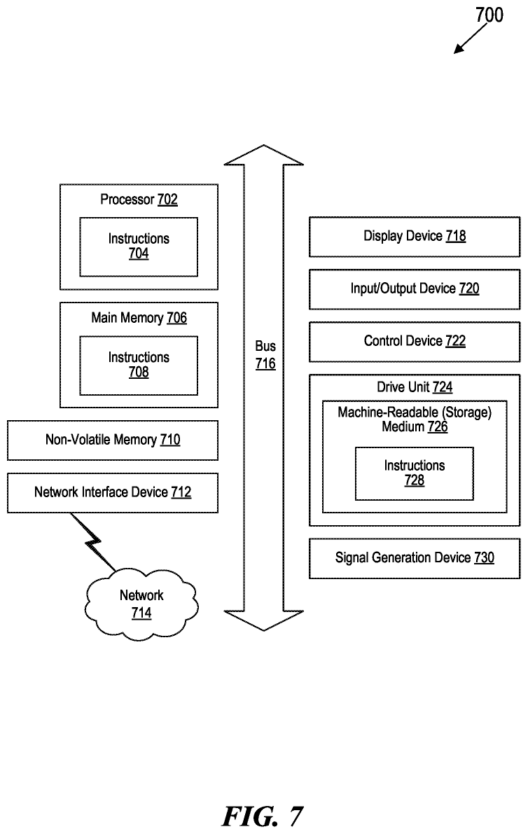

FIG. 7 is a block diagram that illustrates an example of a computer system 700 in which at least some operations described herein can be implemented. As shown, the computer system 700 can include: one or more processors 702, main memory 706, non-volatile memory 710, a network interface device 712, video display device 718, an input/output device 720, a control device 722 (e.g., keyboard and pointing device), a drive unit 724 that includes a storage medium 726, and a signal generation device 730 that are communicatively connected to a bus 716. The bus 716 represents one or more physical buses and/or point-to-point connections that are connected by appropriate bridges, adapters, or controllers. Various common components (e.g., cache memory) are omitted from FIG. 7 for brevity. Instead, the computer system 700 is intended to illustrate a hardware device on which components illustrated or described relative to the examples of the figures and any other components described in this specification can be implemented.

The computer system 700 can take any suitable physical form. For example, the computing system 700 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 700. In some implementation, the computer system 700 can be an embedded computer system, a system-on-chip (SOC), a single-board computer system (SBC) or a distributed system such as a mesh of computer systems or include one or more cloud components in one or more networks. Where appropriate, one or more computer systems 700 can perform operations in real-time, near real-time, or in batch mode.

The network interface device 712 enables the computing system 700 to mediate data in a network 714 with an entity that is external to the computing system 700 through any communication protocol supported by the computing system 700 and the external entity. Examples of the network interface device 712 include a network adaptor card, a wireless network interface card, a router, an access point, a wireless router, a switch, a multilayer switch, a protocol converter, a gateway, a bridge, bridge router, a hub, a digital media receiver, and/or a repeater, as well as all wireless elements noted herein.

The memory (e.g., main memory 706, non-volatile memory 710, machine-readable medium 726) can be local, remote, or distributed. Although shown as a single medium, the machine-readable medium 726 can include multiple media (e.g., a centralized/distributed database and/or associated caches and servers) that store one or more sets of instructions 728. The machine-readable (storage) medium 726 can include any medium that is capable of storing, encoding, or carrying a set of instructions for execution by the computing system 700. The machine-readable medium 726 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory devices 710, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 704, 708, 728) set at various times in various memory and storage devices in computing device(s). When read and executed by the processor 702, the instruction(s) cause the computing system 700 to perform operations to execute elements involving the various aspects of the disclosure.

### REMARKS

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

The terms “example”, “embodiment” and “implementation” are used interchangeably. For example, reference to “one example” or “an example” in the disclosure can be, but not necessarily are, references to the same implementation; and, such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described which can be exhibited by some examples and not by others. Similarly, various requirements are described which can be requirements for some examples but no other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples, but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a mean-plus-function claim will use the words “means for.” However, the use of the term “for” in any other context is not intended to invoke a similar interpretation. The applicant reserves the right to pursue such additional claim forms in either this application or in a continuing application.

1. A system for wireless communication, comprising:
a first Security Edge Protection Proxy (SEPP) network function implemented as a first network node that comprises at least one processor, the first SEPP network function located at an edge of a first telecommunication network, wherein the first SEPP network function is configured to filter control plane signaling traffic for the first telecommunication network;
a first network repository function in communication with the first SEPP network function, wherein the first network repository function is implemented as a second network node that comprises at least one processor; and
a root SEPP discovery node in communication with the first network repository function and a second network repository function of a second telecommunication network,
wherein the root SEPP discovery node comprises at least one processor,
wherein the second network repository function of the second telecommunication network is in communication with a second SEPP network function located at an edge of the second telecommunication network configured to filter control plane signaling traffic for the second telecommunication network, and
wherein the root SEPP discovery node is configured to store information of different SEPP network functions that include the first SEPP network function and the second SEPP network function available in different telecommunication networks globally or regionally.

2. The system of claim 1, wherein the root SEPP discovery node comprises a root SEPP discovery network repository function.

3. The system of claim 1, wherein the root SEPP discovery node comprises a database configured to store the information of different SEPP network functions.

4. The system of claim 1, wherein the first SEPP network function is configured to register with the root SEPP discovery node via the first network repository function.

5. The system of claim 1, wherein the first SEPP network function is configured to deregister with the root SEPP discovery node via the first network repository function.

6. The system of claim 1, wherein the first SEPP network function is configured to subscribe to the root SEPP discovery node via the first network repository function to obtain a status update of other SEPP network functions stored in the root SEPP discovery node.

7. The system of claim 1, wherein the first SEPP network function is configured to unsubscribe from the root SEPP discovery node via the first network repository function.

8. The system of claim 1, wherein the first SEPP network function is configured to:
transmit a discovery request to the root SEPP discovery node via the first network repository function;
obtain, in response to the discovery request, information about the second SEPP network function from the root SEPP discovery node via the first network repository function; and
establish a connection with the second SEPP network function using the information.

9. The system of claim 1, wherein the first network repository function is configured to store an Internet Protocol (IP) address of at least the first SEPP network function or the second SEPP network function.

10. The system of claim 1, wherein the first network repository function is configured to store a mapping between the first SEPP network function and the second SEPP network function.

11-20. (canceled)

21. A device for wireless communication, implemented as a root Security Edge Protection Proxy (SEPP) discovery node, comprising:
a database that is configured to:
store information of a first SEPP network function located at an edge of a first communication network, wherein the first SEPP network function is implemented as a first network node that comprises at least one processor, the first SEPP network function configured to filter control plane signaling traffic for the first communication network and
store information of a second SEPP network function located at an edge of a second communication network, wherein the second SEPP network function is implemented as a second network node that comprises at least one processor, the second SEPP network function configured to filter control plane signaling traffic for the second communication network; and
at least one processor that is configured to:
register or deregister the first SEPP network function and the second SEPP network function.

22. The device of claim 21, wherein the at least one processor is configured to:
receive a subscription request from at least one of the first SEPP network function or the second SEPP network function to obtain a status update of other SEPP network functions stored in the database.

23. The device of claim 22, wherein the at least one processor is configured to:
transmit the status update of other SEPP network functions to at least one of the first SEPP network function or the second SEPP network function.

24. The device of claim 21, wherein the at least one processor is configured to:
receive a discovery request from the first SEPP network function via the first network repository function;
transmit information of the second SEPP network function to the first SEPP network function via the first network repository function.

25. The device of claim 24, wherein the discovery request comprises a Nnrf_NFDiscovery request.

27. The device of claim 24, wherein the at least one processor is configured to:
transmit a confirmation message to the first SEPP network function, wherein the confirmation message indicate a validity period during which the information about the second SEPP network function is cacheable.
